(19) United States
(12) Patent Application Publication
(10) Pub. No.: US 2007/0104958 A1
(43) Pub. Date: May 10, 2007

(54) Epoxy based reinforcing patches with encapsulated physical blowing agents

(75) Inventor: Michael Golden, Waterford, MI (US)

Correspondence Address: GARY C. COHN, PLLC, 1147 NORTH FOURTH STREET, UNIT 6E, PHILADELPHIA, PA, 19123, US

(73) Assignee: Dow Global Technologies, Inc.

(21) Appl. No.: 11/509,187

(22) Filed: Aug. 24, 2006

Related U.S. Application Data
(60) Provisional application No. 60/710,847, filed on Aug. 24, 2005.

(51) Int. Cl. B32B 27/38; C08J 9/00; C09J 163/00; C08L 63/00

(52) U.S. Cl. 428/413; 525/523; 156/330; 521/76

(57) ABSTRACT

Reinforcing sheets for substrates such as steel and other metals have an adhesive layer that contains an epoxy resin, a rubber, a latent curing agent and an encapsulated physical blowing agent.

### CROSS-REFERENCE TO RELATED APPLICATION

This application claims benefit of U.S. Provisional Application 60/710,847, filed Aug. 24, 2005.

### BACKGROUND OF THE INVENTION

This invention relates to reinforcing sheets such as those adapted for applying localized reinforcement to sheet metal or sheet plastic structures.

It is common practice in the automotive industry to apply reinforcing sheets to sheet metal and other parts for localized, lightweight reinforcement. Examples of such reinforcing sheets are described, for example, in U.S. Pat. No. 4,444,818 to Tominaga, U.S. Pat. Nos. 4,766,183 and 4,842,938 to Rizk et al., U.S. Pat. No. 4,803,105 to Kretow et al., U.S. Pat. No. 4,803,108 to Leuchten et al., and U.S. Pat. Nos. 4,900,601, 4,929,483 and 5,092,947 to Hälg et al., and in WO 01/94493. Generally, these reinforcing sheets include one or more layers of a stiffening material and one or more layers of a polymeric material that acts as a binder for the stiffening material as well as an adhesive for securing the reinforcing sheet to a substrate. Often, protective foils, moisture barriers and other layers may be included in the reinforcing sheet.

A common adhesive for these reinforcing sheets is described in U.S. Pat. No. 4,803,105 and in WO 01/94493. That adhesive includes a mixture of an epoxy resin, a curing agent and a carboxy-terminated butadiene-acrylonitrile rubber. In the automotive industry, these reinforcing sheets are typically applied to exterior body panels. Because the epoxy resin in these reinforcing sheets must be cured, the reinforcing sheets are usually applied before the body panel is painted, so that the epoxy resin and paint can be cured simultaneously.

Another example of a reinforcing sheet of this type is described in U.S. Pat. No. 5,151,327 to Nishiyama et al. The adhesive described there is expandable due to the presence of a chemical blowing agent in the formulation. Expansion is desirable because strength of the reinforcement increases with thickness of the reinforcement (which increases the spacing between the substrate surface and the stiffening material). In order to stiffen the reinforcing sheet, the adhesive is highly filled with glass fibers or other fillers. This increases the overall part weight and cost. In addition, the expanded resin tends to have a poor cell structure, with many very large cells. The poor cell structure leads to physical properties that are poorer than desired.

Considerations in the design of the reinforcing sheets include the degree to which the sheet provides reinforcement (typically expressed as the load required to deflect the reinforced substrate by a specified amount), cost, weight, and adhesion. Cost considerations include not only the cost of the reinforcing sheet itself, but also the manufacturing costs incurring in applying it to the substrate and effecting the cure. The reinforcing sheet should for most applications be as light in weight as possible, consistent with cost and performance concerns. Weight is a particular concern in automotive and aerospace applications, where low overall vehicle weight is needed. It is often necessary that the reinforcing sheet adheres well to contaminated or cold substrates, due to the manufacturing environment that is often encountered, especially in automotive applications. In automotive applications, for example, the substrate is often an unpainted body panel that is contaminated with oily materials. In other cases, the substrate is cold for one reason or another when the reinforcing sheet is applied. Cleaning or heating the substrate introduces additional manufacturing costs which are preferably avoided. Therefore, a desirable reinforcing sheet has a low cost and low weight, adheres well even to oily or cold substrates, and is expandable.

### SUMMARY OF THE INVENTION

This invention is a solid, thermally expandable, thermosetting adhesive composition having a specific gravity, prior to expansion, of no greater than 1.0, the adhesive composition comprising (a) an epoxy resin or mixture thereof; (b) a heat-activated curing agent for the epoxy resin or mixture thereof, (c) at least one synthetic rubber and (d) an encapsulated physical blowing agent.

This invention is also an adhesive reinforcing sheet comprising at least one layer of a reinforcing material and at least one layer of a solid, thermally expandable, thermosetting adhesive composition as described above affixed to the reinforcing layer.

This invention is also a method of reinforcing a substrate, comprising applying an adhesive reinforcing sheet as described above to the substrate, and exposing the adhesive reinforcing sheet to temperature conditions sufficient to cause the thermosetting adhesive composition to expand and cure to form an expanded adhesive bonded to the surface of the substrate.

### DETAILED DESCRIPTION OF THE INVENTION

The adhesive composition includes at least one epoxy resin. The epoxy resin or mixture of epoxy resins have an average of at least about 1.8, preferably of at least about 2.0, epoxide groups per molecule. It is preferred that each epoxy resin in a mixture contains at least 1.8 epoxy groups/molecule.

The epoxy resin or mixture thereof may be a solid or liquid at room temperature, provided that the adhesive composition as a whole is a solid at room temperature. It is generally preferred that the epoxy resin or epoxy resin mixture itself be a solid a room temperature. However, even in that case, individual epoxy resins contained within the mixture may be liquids at room temperature. If a solid, the epoxy resin or epoxy resin mixture is preferably softenable at an elevated temperature of between about 50° C. and 150° C. Mixtures of solid and liquid (at room temperature) epoxy resins can be used.

The epoxy resin or mixture thereof has an average epoxide equivalent weight of from 250 to 400, exclusive of any epoxy-terminated rubber materials as described more fully below. This range of equivalent weights has been found to provide the cured adhesive with sufficient mechanical strength that high levels of fillers and/or reinforcing fibers are not required. Individual epoxy resins contained in a mixture may have equivalent weights outside of that range.

A wide variety of polyepoxide compounds such as cycloaliphatic epoxides, epoxidized novolac resins, epoxidized bisphenol A or bisphenol F resins, butanediol polyglycidyl ether, neopentyl glycol polyglycidyl ether or flexibilizing epoxy resins can be used, but generally preferred on the basis of cost and availability are liquid or solid glycidyl ethers of a bisphenol such as bisphenol A or bisphenol F. Halogenated, particularly brominated, resins can be used to impart flame retardant properties if desired. Epoxy resins of particular interest are polyglycidyl ethers of bisphenol A or bisphenol F having an epoxy equivalent weight of about 250 to about 800. Blends of one or more polyglycidyl ethers of bisphenol A or bisphenol F with an epoxy-terminated polyalkylene oxide, particularly an epoxy-terminated poly(propylene oxide) are of particular interest. The epoxy resin may be halogenated (in particular, brominated) if desired in order to impart flame resistance.

Suitable epoxy resins are commercially available. Among these are liquid epoxy resins such as D.E.R. 317, D.E.R. 330, D.E.R. 331, D.E.R. 332, D.E.R. 336, D.E.R. 337 and D.E. R. 383, solid epoxy resins such as D.E.R. 642U, D.E.R. 661, D.E.R. 662, D.E.R 663, D.E. R. 671, D.E.R. 672U, D.E.R. 692, D.E.R. 6155, D.E.R. 666E, D.E.R. 667-20, D.E.R. 667E, D.E.R. 668-20, D.E.R. 669-60, D.E.R. 669E and D.E.R 6225, brominated epoxy resins such as D.E.R. 542, D.E.R. 560 and D.E.R. 593, polyglycol diepoxide resins such as D.E.R. 732, D.E.R. 736, D.E.R. 750 and D.E.R. 755, and epoxy novalac resins such as D.E. N. 425, D.E.N. 431, D.E.N 438 and D.E.N. 439, all available from The Dow Chemical Company.

The epoxy resin (or mixture thereof, exclusive of any epoxy-terminated rubber as described below) will constitute from about 40 to about 85%, especially from about 50 to about 75%, of the total weight of the adhesive composition. 35 The thermosetting adhesive also contains a curing agent. A large number of curing agents are useful, particularly those that require elevated temperatures (i.e., above about 50° C.) to cure. Advantageously, Lewis acids, substituted imidazoles or amine salts can be used as curing agents. Blocked amine curing agents such as those made by the reaction of approximately equimolar amounts of an anhydride and a polyamine are also useful. Such blocked amine curing agents are described in U.S. Pat. No. 4,766,183, the relevant portions of which are incorporated by reference. An especially useful curing agent is dicyandiamide. The curing agent is used in amounts sufficient to provide a complete cure, such as about 0.25 to about 10, preferably about 2 to about 5 percent of the weight of the thermosetting adhesive.

The adhesive contains at least one synthetic rubber. The rubber may be a liquid or a solid at room temperature. If a solid, the rubber is preferably a thermoplastic material that has a softening temperature above 50° C. and below 190° C., especially from about 100 to 150° C. Examples of such synthetic rubbers include polymers of isoprene, polyisobutylene, polybutadiene or other polymers of a conjugated diene, copolymers of a vinyl aromatic monomer with a conjugated diene monomer (such as styrene-butadiene rubbers) and copolymers of a conjugated diene monomer and a nitrile monomer (such as butadiene-acrylonitrile rubbers).

Suitable diene rubbers and conjugated diene/nitrile rubbers are described in WO 01/94493. Diene rubbers and conjugated diene/nitrile rubbers containing not more than 15% by weight polymerized nitrile monomer are of particular interest. The polymerized nitrile monomer preferably constitutes no more than about 3.5%, especially from 1 to about 3.25%, of the total weight of the adhesive composition.

The rubber preferably has a glass transition temperature of less than about −55° C., preferably from about −60 to about −90° C. The molecular weight (Mₙ) of the rubber is suitably about 2000 to about 6000, more preferably from about 3000 to about 5000.

Rubbers having epoxide-reactive groups may be formed into an epoxy-terminated adduct by reaction with a polyepoxide, as described in more detail in WO 01/94493. Rubbers having terminal primary amine, secondary amine or especially carboxylic acid groups are particularly suitable. Suitable carboxyl-functional butadiene and butadiene/acrylonitrile rubbers are commercially available from B. F. Goodrich under the trade names Hycar® 2000X162 carboxyl-terminated butadiene homopolymer and Hycar® 1300X31 carboxyl-terminated butadiene/acrylonitrile copolymer. A suitable amine-terminated butadiene/acrylonitrile copolymer is sold under the tradename Hycar® 1300X21. Polyepoxides as described above are suitable for forming such an adduct. Typically, the rubber and an excess of the polyepoxide are mixed together with a polymerization catalyst such as a substituted urea or phosphine catalyst, and heated to a temperature of about 100 to 250° C. in order to form the adduct. Preferred catalysts include phenyl dimethyl urea and triphenyl phosphine. Preferably, enough of the polyepoxide compound is used that the resulting product is a mixture of the adduct and free polyepoxide compound.

The rubber advantageously constitutes from about 1% to about 10%, preferably from about 2% to about 7%, of the total weight of the adhesive.

The adhesive composition further contains at least one encapsulated physical blowing agent. A “physical” blowing agent is for purposes of this invention, a gas or a liquid that evaporates to generate a gas at a temperature of about 25 to 150° C., and which does not engage in a chemical reaction in order to generate the gas. Suitable physical blowing agents include hydrocarbons such as C₃₋₆ alkanes and alkenes (including linear and branched isomers), C₅₋₆ cycloalkenes and the like, and hydrofluorocarbons having from 2 to 4 carbon atoms. Mixtures of these can be used. Among the suitable hydrofluorocarbon (HFC) blowing agents are HFC-125 (1,1,1,2,2-pentafluoroethane), HFC-134A (1,1,1,2-tetrafluoroethane, HFC-143 (1,1,2-trifluoroethane), HFC 143A (1,1,1-trifluroethane), HFC-152 (1,1-difluoroethane), HFC-227ea (1,1,1,2,3,3,3-heptafluoropropane), HFC-236ca (1,1,2,2,3,3-hexafluropropane), HFC 236fa (1,1,1,3,3,3-hexafluoroethane), HFC 245ca (1,1,2,2,3-pentafluropentane), HFC 356mff (1,1,1,4,4,4-hexafluorobutane) and HFC-365mfc (1,1,1,3,3-pentafluorobutane). Useful alkane and cycloalkane blowing agents include n-butane, isobutane, n-pentane, isopentane, n-hexane, isohexane, cyclopentane, and cyclohexane.

The blowing agent is encapsulated in a material that is a solid at room temperature, but which softens at some temperature between about 40 and 190° C., especially between 50 and 150° C. Upon softening, the blowing agent can expand within the softened encapsulant to form enlarged “balloon” structures, thereby expanding the adhesive composition. It is believed that in most cases the encapsulating material remains intact (i.e. does not rupture) during the expansion process. However, it is within the scope of the invention to use an encapsulant that does in fact rupture during the expansion process. Suitable encapsulating materials include waxes and low-melting thermoplastic polymers. A particularly preferred encapsulating material is a polyvinylchloride resin. Encapsulated physical blowing agents are commercially available. An example of a suitable encapsulated physical blowing agent is Expancel™ 551DU from Akzo-Nobel. That material includes isobutane encapsulated within a polyvinyl chloride shell.

The encapsulated blowing agent preferably constitutes from about 1 to about 5 percent by weight of the adhesive composition.

It is especially preferred to use a combination of an encapsulated physical blowing agent together with one or more chemical blowing agents. A “chemical” blowing agent is one which decomposes or otherwise engages in a chemical reaction to form a gas under the conditions at which the adhesive composition is expanded. Particularly suitable chemical blowing agents generate carbon dioxide or nitrogen. Azo blowing agents such as azobisisobutyronitrile and azobisdicarbonamide, nitroso compounds such as dinitrosopentamethylenetetramine and hydrazide compounds such as p-toluenesulfonyl hydrazide and 4,4′-oxybenzenesulfonyl hydrazide are suitable. When used, the chemical blowing agent advantageously constitutes from about 1-5% by weight of the adhesive composition.

The blowing agents most suitably are provided in proportions sufficient to cause the adhesive composition to expand to about 200 to 350% of its original volume.

The adhesive composition is formulated to have a specific gravity of no greater than 1.0. This is conveniently achieved by (1) using at most small (up to 15%, especially about 2 to about 10%, by weight of the adhesive composition) amounts of inorganic filler materials and/or (2) incorporating a quantity of gas-filled microspheres into the composition. Microspheres are not considered as fillers for purposes of this invention.

Suitable fillers include talcs, clays, silicas, calcium carbonate, graphite, glass, carbon black, plastic powders such as ABS, and the like. Magnetic particles such as ferromagnetic particles may be used as fillers, as well. Fillers such as fumed silica, bentonite clay and montmorillonite clay can act as thixotropic agents. Thixotropic fillers are preferably used in amounts up to about 8% by weight of the adhesive composition. Fillers also include fibrous materials such as fiberglass.

Suitable microspheres include those made from inorganic materials such as glass and silica-alumina ceramics, or polymeric materials such as epoxy resin, unsaturated polyester resin, silicone resin, phenolics, polyvinyl alcohol, polyvinyl chloride, polypropylene, and polystyrene. In addition, fly ash that is in the form of hollow particles can be used. Examples of commercially available fly ash of this type are sold by Boliden Intertrade, Inc., under the trade names Fillite 100 and Fillite 150. Glass microspheres are most preferred. These microspheres most advantageously have average diameters of from about 5 to about 150 microns, preferably from about 20 to about 85 microns. In addition, the microspheres advantageously have a bulk density of from about 0.1 to about 0.5 g/cc. If desired, the microspheres may be surface treated with an interfacial adhesion promoter such as a silane compound. When used, the microspheres typically constitute from about 5 to about 25%, especially from about 10 to 20%, by weight of the adhesive composition.

The adhesive composition may include a plasticizer for impact and thermal shock resistance improvement. Advantageously, various benzoates, adipates, terephthalates and phthalates can be used as the plasticizer. A terephthalate or phthalate, for example dibutyl phthalate, is preferred.

In addition, the adhesive composition can further contain a flame retardant, such as hydrated alumina or antimony oxide.

The adhesive composition is applied to at least one side of a reinforcing layer. The reinforcing layer is preferably made of a stiff yet flexible construction, in order to provide reinforcement when applied to a substrate, and yet conform to the shape of the substrate. Preferred reinforcing materials are fibers of stiff materials such as glass, polyamide resin, polypropylene resin, carbon and the like, as well as aluminum sheet or foil, films of high melting thermoplastic resins such as Mylar, that may be fiber-reinforced. More preferred reinforcing materials are woven fabrics of stiff fibers as just described, especially woven glass fabrics. Mixtures of two or more different fibers can be woven together if desired. For example, carbon fibers may be woven into a glass fabric to increase stiffness at a moderate cost. The reinforcing layer preferably has a thickness of 0.003 inch to 0.050 inch (0.076-1.27 mm).

The reinforcing layer may have a planar and/or smooth configuration, or may include three-dimensional features to further increase stiffness and/or adapt the reinforcing sheet for a particular application. For example, the reinforcing layer may have a ribbed configuration such as is described in FIGS. 3-5 of U.S. Pat. No. 4,803,105, the relevant portions of which are incorporated herein by reference.

Another suitable reinforcing layer is a honeycomb structure as described in U.S. Pat. No. 4,803,105. These honeycomb structures include a perforated honeycomb member having columns that define cell apertures with open ends. The honeycomb structure is suitably formed of any material that remains stable up to the curing temperature of the thermosetting adhesive and exhibits sufficient adhesion to the thermosetting adhesive layer and sufficient flexibility to conform to the shape of the panel to be reinforced. Advantageously, the honeycomb structure is formed of a metal alloy plate. Because of its light weight, corrosion resistance, ready accessibility, inexpensive cost and high flexibility, aluminum is most preferred for forming the honeycomb structure.

The columns of the honeycomb structure are integrally connected to form a multitude of cell apertures with open ends. The cells of the honeycomb structure may be hexagonal, triangular, square, polyhedral or other convenient shapes. The columns of the honeycomb structure are sufficiently thick, and the cell apertures defined by the columns have a suitable cell size and core density, such that the honeycomb structure maintains its integrity while maintaining the capability to conform to the shape of the substrate and without unacceptably increasing the weight of the reinforcing sheet. The preferred aluminum honeycomb columns suitably have a thickness of 0.0005 inch to 0.005 inch (0.013-0.13 mm, preferably 0.0007 inch to 0.004 inch (0.0018-0.1 mm). The cell apertures suitably have a cell size of 1/16 inch to ⅞ inch (1.6-22.2 mm), preferably 3/16 inch to 5/16 inch (4.8-8.0 mm). The honeycomb member suitable has a density of 1.0 pound per cubic foot to 12.0 pounds per cubic foot (1.6-19.2 kg/m³), preferably 3.0 pounds per cubic foot to 8.0 pounds per cubic foot (4.8-12.8 kg/m³). The honeycomb member suitably has a thickness of 1/16 inch to 4 inches (1.6-102 mm), preferably ⅛ inch to ¾ inch (3.2-19 mm).

In addition, the reinforcing sheet may contain one or more additional functional layers, such as a moisture barrier layer as described in U.S. Pat. No. 4,803,108. The presence of such a moisture impermeable barrier permits the reinforcing sheet to be stored for long periods of time, for example three to six months, with minimal adverse effects due to the absorption of moisture, even under humid conditions. Another useful functional layer is a release sheet, typically paper, which covers the exposed surface of the adhesive layer that is brought into contact with the substrate to be reinforced. If desired, a slit, heat-shrinkable protection foil of the type described in U.S. Pat. No. 4,900,601 can be used on the surface of the adhesive layer.

The reinforcing sheet advantageously is prepared by applying a layer of the adhesive composition to the reinforcing layer. A convenient way of accomplishing this is to spread a layer of the adhesive onto a release layer or protection foil with a coating knife to a uniform thickness suitably of 0.01 inch to 0.10 inch (0.25-2.5 mm), preferably 0.02 inch to 0.05 inch (0.5-1.25 mm). The reinforcing layer is then placed on the thermosetting adhesive layer and pressed in with a pressure roll. The entire reinforcing sheet is then pressed with a roller to provide a sheet with total thickness suitably of 0.03 inch to 0.30 inch (0.75-7.5 mm), preferably 0.04 inch to 0.10 inch (1.0-2.5 mm).

To apply the reinforcing sheet to the substrate to be reinforced, the exposed surface of the adhesive layer is brought in contact with the panel. An advantage of the reinforcing sheet of this invention is that it adheres well to substrates that are somewhat oily or somewhat cold.

The substrate and applied reinforcing sheet are subsequently heated to cure the thermosetting adhesive. This is conveniently done at a temperature of from about 150° C. to about 200° C., for a period of about 15 minutes to about 1 hour. This curing step can be done simultaneously with other treatments requiring heating, such as curing paints or E-coats.

The following examples are provided to illustrate the invention, but are not intended to limit the scope thereof. All parts and percentages are by weight unless otherwise indicated.

### EXAMPLE 1 AND COMPARATIVE SAMPLE A

20 parts of a liquid epoxy resin (D. E. R. 331, from The Dow Chemical Company), 30 parts of a solid epoxy resin (D. E. R. 661, from The Dow Chemical Company), 15 parts of an epoxy-terminated poly(propylene oxide) (D. E. R. 732 from The Dow Chemical Company) and 5 parts of a liquid poly(isobutylene) (Indopol™ H-6000 from Innovene) are heated together in a mixer at 60° C. until homogeneous. The average epoxy equivalent weight of the blend of the three epoxy resins is approximately 309. Under vacuum, 6 parts bentonite clay, 1 parts zinc oxide, 3 parts azodicarbonamide, 3 parts of an encapsulated isobutane (Expancel™ 551 DU from Akzo-Nobel) and 4 parts of dicyandiamide are mixed in. Then, 13 parts of glass microspheres (from 3M Corporation) are added. The compounded adhesive is discharged onto a laminating line where it is applied to a woven fiberglass reinforcing backing having a thickness of 0.0065-0.0080 inches (0.165-0.203 mm), and a weight of 6.01-6.39 oz/square yard (˜204-217 g/m²), to form a laminate having a nominal thickness of approximately 1 mm. The resulting laminate is cooled to solidify the adhesive, and cut into sample pieces of approximately 25.4×100×1 mm. The adhesive has a specific gravity of less than 1.0.

Samples are applied to a 0.8 mm steel sheet and cured by heating for 20 minutes at 170° C. As the samples cure, they expand to 250-280% of their original thickness.

The reinforcing effect of the reinforcing sheet is determined by measuring the load that must be applied to achieve a specified deflection of the reinforced structure. A 1″×6″ (2.5×15 cm) strip of the reinforced structure is suspended over two points located 4″ (10 cm) apart and 1″ (2.5 cm) from the respective ends of the test structure. Load is applied to the midpoint of the structure and the resulting deflection of the structure is measured. Under this test, a load of 63 newtons is required to produce a 2 mm deflection. A load of 113 newtons is required to produce a 4 mm deflection and a load of 173 newtons is required to produce a deflection of 8 mm.

Additional samples of the reinforcing sheet are prepared in the same manner, at nominal (unexpanded) thicknesses of 0.80, 1.00, 1.30 and 1.50 mm. For comparison, reinforcing sheets (Comparative Sample A) are made at the same nominal thicknesses, using an adhesive composition as described in WO 01/94493 that contains only a chemical blowing agent. The load required to produce a deflection of 2 mm is measured for each of these sheets, using the test described above. Using the same test, the load required to produce failure (irreversible deformation or delamination) is measured. Results are as follows:

| Example or | | Load | Load to |
|---|---|---|---|
| Comparative Sample | Unexpanded | to produce 2 mm | product |
| No. | Thickness (mm) | deflection (N) | failure (N) |
| 1 | 0.8 | 41 | 139 |
| A* | 0.8 | 29 | 120 |
| 1 | 1.0 | 61 | 159 |
| A* | 1.0 | 40 | 130 |
| 1 | 1.3 | 91 | 188 |
| A* | 1.3 | 70 | 169 |
| 1 | 1.5 | 111 | 208 |
| A* | 1.5 | 91 | 180 |

*Not an example of this invention.

The improved load-bearing capacity of the reinforcing sheet of the invention is believed to be due to a greater expansion of the adhesive during the curing step, due to the activity of the physical blowing agent.

What is claimed is:

1. A solid, thermally expandable, thermosetting adhesive composition having a specific gravity, prior to expansion, of no greater than 1.0, the adhesive composition comprising (a) an epoxy resin or mixture thereof; (b) a heat-activated curing agent for the epoxy resin or mixture thereof, (c) at least one synthetic rubber and (d) an encapsulated physical blowing agent.

2. The adhesive composition of claim 1 wherein the epoxy resin or mixture thereof has an average epoxy equivalent weight of 250 to 400.

3. The adhesive composition of claim 2 which contains no more than 15% by weight of a filler, based on the weight of the adhesive composition.

4. The adhesive composition of claim 3 which contains from 10 to 20% by weight of microspheres, based on the weight of the adhesive composition.

5. The adhesive composition of claim 4, wherein the synthetic rubber is a diene rubber, a conjugated diene/nitrile rubber or mixture thereof.

6. The adhesive composition of claim 5, wherein the physical blowing agent is a C₃₋₆ alkane or alkene, a C₅₋₆ cycloalkene; a hydrofluorocarbon having from 2 to 4 carbon atoms, or mixture of two or more of the foregoing.

7. An adhesive reinforcing sheet comprising at least one layer of a reinforcing material and at least one layer of a solid, thermally expandable, thermosetting adhesive composition of claim 1 affixed to the reinforcing layer.

8. An adhesive reinforcing sheet comprising at least one layer of a reinforcing material and at least one layer of a solid, thermally expandable, thermosetting adhesive composition of claim 2 affixed to the reinforcing layer.

9. An adhesive reinforcing sheet comprising at least one layer of a reinforcing material and at least one layer of a solid, thermally expandable, thermosetting adhesive composition of claim 3 affixed to the reinforcing layer.

10. An adhesive reinforcing sheet comprising at least one layer of a reinforcing material and at least one layer of a solid, thermally expandable, thermosetting adhesive composition of claim 4 affixed to the reinforcing layer.

11. An adhesive reinforcing sheet comprising at least one layer of a reinforcing material and at least one layer of a solid, thermally expandable, thermosetting adhesive composition of claim 5 affixed to the reinforcing layer.

12. An adhesive reinforcing sheet comprising at least one layer of a reinforcing material and at least one layer of a solid, thermally expandable, thermosetting adhesive composition of claim 6 affixed to the reinforcing layer.

13. A method of reinforcing a substrate, comprising applying an adhesive reinforcing sheet of claim 7 to the substrate, and exposing the adhesive reinforcing sheet to temperature conditions sufficient to cause the thermosetting adhesive composition to expand and cure to form an expanded adhesive bonded to the surface of the substrate.

14. A method of reinforcing a substrate, comprising applying an adhesive reinforcing sheet of claim 8 to the substrate, and exposing the adhesive reinforcing sheet to temperature conditions sufficient to cause the thermosetting adhesive composition to expand and cure to form an expanded adhesive bonded to the surface of the substrate.

15. A method of reinforcing a substrate, comprising applying an adhesive reinforcing sheet of claim 9 to the substrate, and exposing the adhesive reinforcing sheet to temperature conditions sufficient to cause the thermosetting adhesive composition to expand and cure to form an expanded adhesive bonded to the surface of the substrate.

16. A method of reinforcing a substrate, comprising applying an adhesive reinforcing sheet of claim 10 to the substrate, and exposing the adhesive reinforcing sheet to temperature conditions sufficient to cause the thermosetting adhesive composition to expand and cure to form an expanded adhesive bonded to the surface of the substrate.

17. A method of reinforcing a substrate, comprising applying an adhesive reinforcing sheet of claim 11 to the substrate, and exposing the adhesive reinforcing sheet to temperature conditions sufficient to cause the thermosetting adhesive composition to expand and cure to form an expanded adhesive bonded to the surface of the substrate.

18. A method of reinforcing a substrate, comprising applying an adhesive reinforcing sheet of claim 12 to the substrate, and exposing the adhesive reinforcing sheet to temperature conditions sufficient to cause the thermosetting adhesive composition to expand and cure to form an expanded adhesive bonded to the surface of the substrate.
